(19) United States
(12) Patent Application Publication
(10) Pub. No.: US 2021/0150247 A1
(43) Pub. Date: May 20, 2021

(54) IMAGE PATTERN RECOGNITION SYSTEM AND METHOD

(71) Applicants: INVENTEC (PUDONG) TECHNOLOGY CORPORATION, Shanghai City (CN); INVENTEC CORPORATION, Taipei City (TW)

(72) Inventors: Chun-Yen KUO, Taipei City (TW); Jiun-Kuei JUNG, Taipei City (TW)

(73) Assignees: INVENTEC (PUDONG) TECHNOLOGY CORPORATION, Shanghai City (CN); INVENTEC CORPORATION, Taipei City (TW)

(21) Appl. No.: 16/718,810

(22) Filed: Dec. 18, 2019

(30) Foreign Application Priority Data
Nov. 19, 2019 (CN) 201911136693.6

(51) Int. Cl. G06K 9/32; G06K 9/62; G06F 17/16

(52) U.S. Cl. CPC G06K 9/3258; G06K 2209/15; G06F 17/16; G06K 9/6256

(57) ABSTRACT

An image pattern recognition method, comprises: performing a machine learning algorithm by a processor to identify a frame of a surface in an image, wherein the surface has a pattern, and an area enclosed by the frame includes the pattern, performing a matrix conversion procedure by the processor to calibrate the angle of the image based on the frame, and performing a pattern recognition procedure by the processor to identify the pattern to output a recognition information corresponding to the pattern to an output device.

### CROSS-REFERENCE TO RELATED APPLICATIONS

This non-provisional application claims priority under 35 U.S.C. § 119(a) on Patent Application No(s). 201911136693.6 filed in China on Nov. 11, 2019, the entire contents of which are hereby incorporated by reference.

### BACKGROUND

### Technical Field

This disclosure relates to an image pattern recognition system and method, especially to an image pattern recognition system and method that can be used to calibrate a pattern of a surface in an image.

### Related Art

In order to monitor traffic conditions or record license plates to charge parking fees, the development of license plate recognition technology has become more mature. Recognition systems used on license plate has been installed in parking lots, which not only makes the operation of the parking lots more efficient, but also reduces the labor costs required when the operating parking lots.

It is known that when identifying the license plate number, artificial intelligence usually uses object detection technology to find the bounding box of the license plate in the image., and then uses license plate recognition technology to analyze the pattern within the bounding box to obtain the license plate number. However, this approach may be affected in many scenarios due to the shooting angle or perspective distortion caused by the tilt of the license plate itself, making it difficult to obtain a correct recognition result even if the license plate is detected. In addition, the result of license plate recognition may likely be affected if there are other decorative patterns on the license plate other than the license plate number.

### SUMMARY

According to one or more embodiment of this disclosure, an image pattern recognition method, configured to be performed by a processor, comprising: performing a machine learning algorithm to identify a frame of a surface in an image, wherein the surface has a pattern, and an area enclosed by the frame includes the pattern; performing a matrix conversion procedure to calibrate a display angle of an image inside the frame; and performing a pattern recognition procedure to identify the pattern for outputting a recognition information corresponding to the pattern to an output device.

According to one or more embodiment of this disclosure, an image pattern recognition system, comprising: a camera configured to obtain an image; a processor in communicable connection with the camera to receive the image, wherein the processor identifies a frame of a surface in the image via a machine learning algorithm, the surface has a pattern, an area enclosed by the frame includes the pattern, the processor calibrates a display angle of an image inside the frame via a matrix conversion procedure, and the processor further performs a pattern recognition procedure to identify the pattern for outputting a recognition information corresponding to the pattern; and an output device in communicable connection with the processor to receive the recognition information and to present the recognition information.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is an illustration of a block diagram of a pattern recognition system according to one embodiment of the present disclosure;

FIG. 2 is an illustration of a flow chart of a pattern recognition method according to one embodiment of the present disclosure; and

FIG. 3 is an illustration of a schematic diagram of a pattern recognition system according to one embodiment of the present disclosure.

### DETAILED DESCRIPTION

Please refer to FIG. 1, FIG. 1 is an illustration of a block diagram of a pattern recognition system according to one embodiment of the present disclosure. For better understanding, the following embodiments of the present disclosure are explained using an example of license plate recognition., however the present disclosure is not limited to license plate recognition. The image pattern recognition system of the embodiment comprises a camera 1, a processor 2, and an output device 3.

Please continue referring to FIG. 1, the camera 1 is configured to capture an image, wherein the image includes a surface to be identified. For example, the image captured by the camera 1 includes a license plate, and the surface to be identified is the surface of the license plate. The camera 1 can be a video camera or an image camera installed in areas such as at the side of the road, highway or parking lots, however the present disclosure is not limited thereto.

Please continue referring to FIG. 1, the processor 2 is in communicable connection with the camera 1 to receive the image captured by the camera 1. The processor 2 then identify a frame of the surface in the image by machine learning algorithm, wherein the surface has a pattern, and an area enclosed by the frame at least includes the pattern. Take the above-mentioned license plate as an example, the pattern is preferably the license plate number of the license plate in the image, and the frame is preferably the frame that encloses the license plate number. The processor 2 can be a central processing unit (CPU) or other devices have computing capabilities. The machine learning algorithm performed by the processor 2 can be realized by neural network of acritical intelligence (AI) technology, and is preferably based on convolutional neural network (CNN). The machine learning algorithm can also be based on regression model, the present disclosure is not limited thereto.

In detail, take the above-mentioned license plate as an example, the processor 2 identifying the frame of the surface in the image by machine learning algorithm is: multiple training images having license plates and standard frames that enclose the numbers of these license plates are provided to the processor 2. The processor 2 then compares the estimated frames obtained from the machine learning algorithm and the standard frames, and returns a difference data between each point of the estimated frames and each apex of the standard frames to the machine learning algorithm for parameter adjustment. Accordingly, the parameters used in the machine learning algorithm are adjusted to be able to enclose the estimated frame that has the same enclosed area as the standard frame in these training images. In addition, the license plates in these training images preferably are located in various locations in the acquired images obtained by the camera, and take up various percentage relative to the entire acquired images. For example, the license plates can be located in the center, corner, bottom, top or side of the acquired image, and take up 10%, 30%, 60% or even 80% of the entire acquired image. Accordingly, the machine learning algorithm executed by the processor 2 can be more efficiently applied to effects caused by factors such as perspective distortion of the shooting angle, distance, or lens fisheye distortion, and thus more accurately determine the position of the frame.

Please continue referring to the above description, the frame identified by the processor 2 has at least one nonlinear turning corner, and the frame is preferably a quadrilateral. Meaning, the frame preferably has four nonlinear turning corners, and the frame is a quadrilateral formed by straight lines connecting the four nonlinear turning corners.

Take the above-mentioned license plate as an example, the frame of an actual license plate is usually a rectangle formed by two pairs of parallel lines. However, because the image may be affected by the setting position/angle of the camera 1, perspective distortion may occur, which causes two lines actually with equal width appear as two lines with different width in the image. In other words, the one line that is closer to the camera 1 in the image appears to be longer than the other line that is farther from the camera, causing the fame that is actually a parallelogram may appear to be a trapezoid in the image, or even a quadrilateral with two pairs of lines that are not parallel to each other.

In order to solve the above-mentioned problem of perspective distortion, the present disclosure uses the processor 2 to perform a matrix conversion procedure to calibrate a display angle of an image inside the frame based on the coordinates of the nonlinear turning corners, wherein the image inside the frame includes the surface, so that the quadrilateral appeared as trapezoid or as quadrilateral with four lines that are not parallel to each other caused by perspective distortion in the image can be calibrated back to a rectangle or close to a rectangle. Meaning, the image inside the frame, including the surface, is calibrated along with the frame. Accordingly, the surface and the pattern on the surface in the image can be adjusted to a position of the corresponding rectangular fame by matrix conversion procedure. In the present embodiment, the matrix conversion procedure is preferably a perspective transformation, the present disclosure is not limited thereto.

Pleaser continue referring to FIG. 1, after the processor 2 calibrates the display angle of the image, the processor 2 performs a pattern recognition procedure and outputs a recognition information corresponding to the pattern. Take the above-mentioned license plate as an example, the recognition information outputted by the processor 2 after the performing of the pattern recognition procedure is, for example, the license plate number of the license plate. When the surface in the image contains patterns such as texts and symbols, then the recognition information further includes the texts and symbols, the present disclosure is not limited thereto.

Pleaser continue referring to FIG. 1, the output device 3 of the present embodiment is in communicable connection with the processor 2 to receive the recognition information outputted by the processor. Accordingly, the output device 3 can present the recognition information. In detail, the output device 3 is, for example, a terminal device, a display screen, an audio system that is installed in a monitoring center. The output device 3 can also be a communication device that outputs the recognition information to the server of the monitoring center for the monitoring center to communicate with the pass by vehicles. However, the present disclosure is not limited thereto.

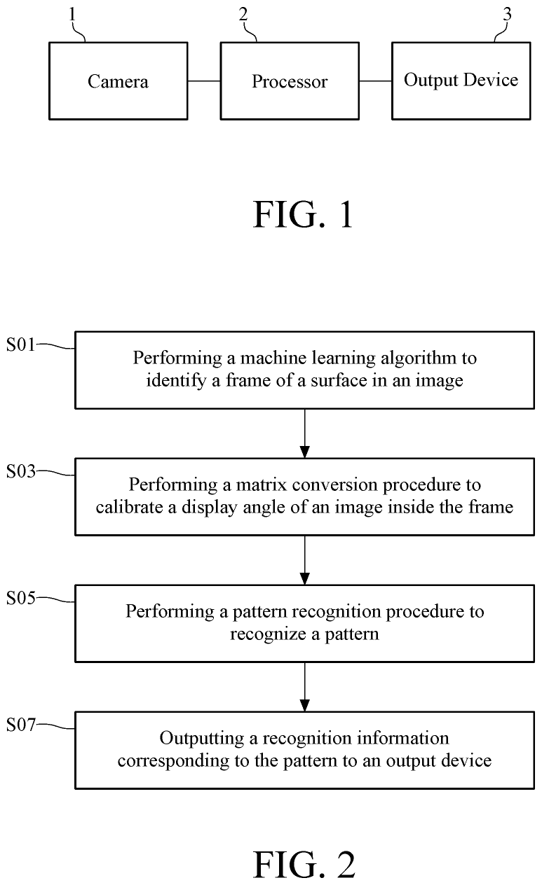

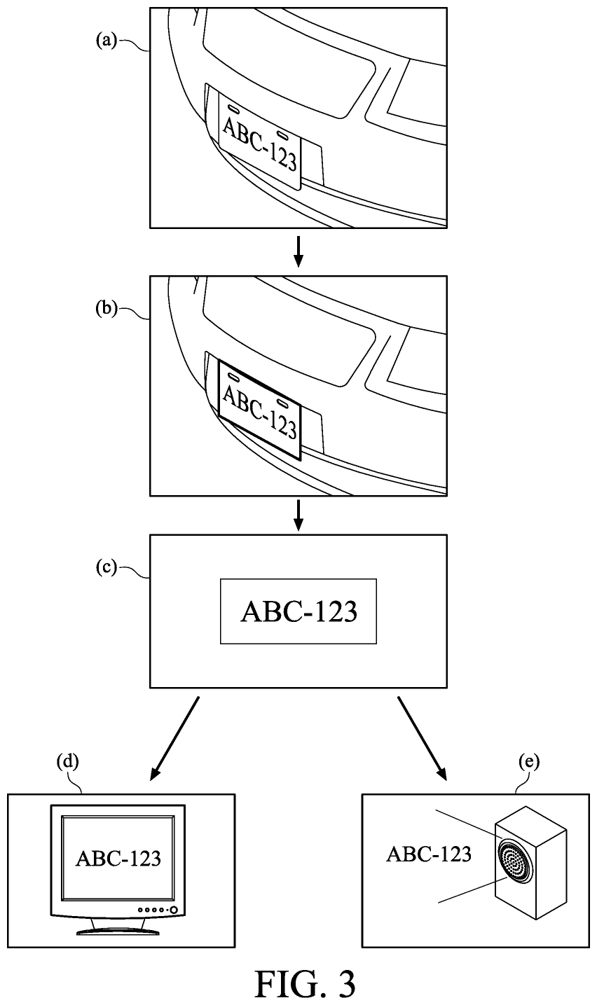

Please refer to FIG. 1, FIG. 2 and FIG. 3 together, wherein FIG. 2 is a flow chart of a pattern recognition method according to one embodiment of the present disclosure; FIG. 3 is an illustration of a schematic diagram of a pattern recognition system according to one embodiment of the present disclosure.

Please refer to step S01: performing the machine learning algorithm by the processor 2 to identify the frame of the surface in the image. Specifically, the image is obtained by the camera 1, and the image preferably includes the surface of a license plate as shown in FIG. 3(a). The surface obtained by the processor 2 performing the machine learning algorithm has a pattern. As shown in FIG. 3(b), the area enclosed by the frame which is obtained by the processor 2 performing the machine learning algorithm includes the pattern.

Please continue referring to step S01, take the above-mentioned license plate as an example, the surface disclosed in step S01 is the license plate, and the image is the image that includes the license plate (image). The frame of the surface obtained by the processor 2 performing the machine learning algorithm is preferably a bounding box that can enclose the license plate number. For example, when the license plate has both license plate number and patterns that are not the license plate number, the area enclosed by the frame that is obtained by the machine learning algorithm includes preferably only the license plate number. Meaning, the pattern is located in the area enclosed by the frame. However, the frame of the surface can also be the frame of the license plate. The frame has a nonlinear turning corner, wherein the frame preferably is a quadrilateral formed by straight lines connecting the four nonlinear turning corners. However, the present disclosure is not limited thereto. Accordingly, the image can be more accurately calibrated in the subsequent calibration step (S03).

Please refer to step S03, when the frame of the surface is obtained, the pattern recognition method disclosed in the present embodiment performs a matrix conversion procedure in step S03 by the processor 2. The image is calibrated based on the frame of the surface and the coordinates of the nonlinear turning corners, so that the license plate is adjusted from the form shown in FIG. 3(b) to the form shown in FIG. 3(c). The implementation of the matrix conversion procedure in step S03 is the matrix conversion procedure disclosed in the embodiment of FIG. 1, therefore won't be repeated herein.

Please refer to both step S01 and S03, in other words, the machine learning algorithm disclosed in step S01 is configured to compare the reference image with the image obtained by the camera 1 to output the frame and the coordinates of the nonlinear turning corners. The matrix conversion procedure disclosed in step S03 is configured to calibrate the surface in the image to a proper display angle, so that the pattern within the frame can be redistributed in the calibrated rectangular frame by the matrix conversion procedure.

Please continue referring to step S05, when the processor 2 completes the calibration of the display angle of the image, the processor 2 then performs the pattern recognition procedure on the calibrated image to recognize the pattern. Continuing the example of the license plate mentioned above, the pattern recognition procedure is, in this example, preferably a license plate recognition procedure, to identify the license plate number in the image. However, the present disclosure is not limited thereto.

When the recognition of the pattern (the license plate number) in step S05 is completed, the processor 2 outputs the recognition information corresponding to the pattern to the output device 3 in step S07. The output device 3 can then present the recognition information to the monitoring center in various forms. For example, the recognition information is transmitted to the output device 3 for the output device 3 to present the recognition information in various forms. The recognition information is, for example, “ABC-123”. Then, the means of outputting the recognition information by the output device 3 can be displaying the text of “ABC-123” on a display screen as shown in FIG. 3(d), or outputting an audio message of “ABC-123” by an audio device as shown in FIG. 3(e). The system of a parking lot or a traffic monitoring center can record and perform subsequent information processing on pass by vehicles. However, the present disclosure is not limited thereto.

In view of the above description, the image pattern recognition system and method according to one or more embodiments of the present disclosure, when the surface of the license plate obtained by the camera is tilted due to perspective distortion, or due to the tilt angle of the license plate itself, the result of pattern recognition can be made more accurate by calibrating the display angle of the surface in the image. In addition, the image pattern recognition system and method according to one or more embodiments of the present disclosure, when the license plate has other graphics besides the license plate number, the result of pattern recognition will not be distorted by the influence of other graphics.

The present disclosure has been disclosed above in the embodiments described above, however it is not intended to limit the present disclosure. It is within the scope of the present disclosure to be modified without deviating from the essence and scope of it. It is intended that the scope of the present disclosure is defined by the following claims and their equivalents.

What is claimed is:

1. An image pattern recognition method, configured to be performed by a processor, comprising:
performing a machine learning algorithm to identify a frame of a surface in an image, wherein the surface has a pattern, and an area enclosed by the frame includes the pattern;
performing a matrix conversion procedure to calibrate a display angle of an image inside the frame; and
performing a pattern recognition procedure to identify the pattern to output a recognition information corresponding to the pattern to an output device.

2. The image pattern recognition method according to claim 1, wherein the frame has a nonlinear turning corner.

3. The image pattern recognition method according to claim 1, wherein the machine learning algorithm is based on a convolutional neural network (CNN).

4. The image pattern recognition method according to claim 1, wherein the matrix conversion procedure is perspective transformation.

5. The image pattern recognition method according to claim 1, wherein the frame is a quadrilateral.

6. An image pattern recognition system, comprising:
a camera configured to obtain an image;
a processor in communicable connection with the camera to receive the image, wherein the processor identifies a frame of a surface in the image via a machine learning algorithm, the surface has a pattern, an area enclosed by the frame includes the pattern, the processor calibrates a display angle of an image inside the frame via a matrix conversion procedure, and the processor further performs a pattern recognition procedure to identify the pattern for outputting a recognition information corresponding to the pattern; and
an output device in communicable connection with the processor to receive the recognition information and to present the recognition information.

7. The image pattern recognition system according to claim 6, wherein the frame has a nonlinear turning corner.

8. The image pattern recognition system according to claim 6, wherein the machine learning algorithm is based on a convolutional neural network (CNN).

9. The image pattern recognition system according to claim 6, wherein the matrix conversion procedure is perspective transformation.

10. The image pattern recognition system according to claim 6, wherein the frame is a quadrilateral.
